(19) United States
(12) Patent Application Publication
(10) Pub. No.: US 2026/0147240 A1
(43) Pub. Date: May 28, 2026

(54) DISPLAY DEVICE

(71) Applicant: Japan Display Inc., Tokyo (JP)

(72) Inventors: Takashi OTA, Tokyo (JP); Nobuyuki SUZUKI, Tokyo (JP); Takaaki WATANABE, Tokyo (JP); Chikyu NAKAOKA, Tokyo (JP)

(73) Assignee: Japan Display Inc., Tokyo (JP)

(21) Appl. No.: 19/401,772

(22) Filed: Nov. 26, 2025

(30) Foreign Application Priority Data
Nov. 27, 2024 (JP) 2024-206558

(51) Int. Cl. G02F 1/1335; G02F 1/13357

(52) U.S. Cl. CPC G02F 1/133607; G02F 1/133603

(57) ABSTRACT

According to one embodiment, a display device includes a plurality of light emitting portions arranged in a first direction, a liquid crystal panel inclined relative to a normal to a light emitting surface which each of the plurality of light emitting portions has, a prism sheet located between the plurality of light emitting portions and the liquid crystal panel and having a plurality of prisms on a side facing the plurality of light emitting portions, and a lens element located between the prism sheet and the liquid crystal panel and including a plurality of lenticular lenses arranged in the first direction on a side facing the liquid crystal panel.

### CROSS-REFERENCE TO RELATED APPLICATIONS

This application is based upon and claims the benefit of priority from Japanese Patent Application No. 2024-206558, filed Nov. 27, 2024, the entire contents of which are incorporated herein by reference.

### FIELD

Embodiments described herein relate generally to display device.

### BACKGROUND

In display devices installed in vehicles, a technique of displaying two images on a screen and divided these two images into one image and the other image has been known. One image can be visually recognized by directly seeing the screen. The other image can be visually recognized as an image projected onto a front shield or the like.

This display device demands improvement of display quality

### BRIEF DESCRIPTION OF THE DRAWINGS

FIG. 1 is a schematic view showing an exterior appearance of a display device DSP.

FIG. 2 is a schematic view showing a configuration of the display device DSP in the first embodiment.

FIG. 3 is a view showing part of a prism sheet 10 in an enlarged manner.

FIG. 4 is a view showing part of a lens element 20 in an enlarged manner.

FIG. 5 is a schematic A-A cross-sectional view of the display device DSP shown in FIG. 1 according to the first embodiment.

FIG. 6 is a schematic B-B cross-sectional view of the display device DSP shown in FIG. 1 according to the first embodiment.

FIG. 7 is a view describing effects of a lenticular lens LEN and an isotropic diffusion sheet DS.

FIG. 8 is a schematic view showing a configuration example of a display device DSP according to the second embodiment.

FIG. 9 is a view showing part of an optical element 30 in an enlarged manner.

FIG. 10 is a schematic A-A cross-sectional view of the display device DSP shown in FIG. 1 according to the second embodiment.

FIG. 11 is a schematic B-B cross-sectional view of the display device DSP shown in FIG. 1 according to the second embodiment.

### DETAILED DESCRIPTION

In general, according to one embodiment, a display device includes a plurality of light emitting portions arranged in a first direction, a liquid crystal panel inclined relative to a normal to a light emitting surface which each of the plurality of light emitting portions has, a prism sheet located between the plurality of light emitting portions and the liquid crystal panel and having a plurality of prisms on a side facing the plurality of light emitting portions, and a lens element located between the prism sheet and the liquid crystal panel and including a plurality of lenticular lenses arranged in the first direction on a side facing the liquid crystal panel. The plurality of light emitting portions are configured to emit illumination light from the light emitting surface. The prism sheet is configured to split the illumination light into transmitted light and refracted light. The lens element is configured to diffuse the transmitted light and the refracted light. The liquid crystal panel is configured to be illuminated by the transmitted light and the refracted light and display a first image based on the transmitted light and a second image based on the refracted light.

According to an embodiment, a display device includes a plurality of light emitting portions arranged in a first direction, a liquid crystal panel inclined relative to a normal to a light emitting surface which each of the plurality of light emitting portions has, and an optical element located between the plurality of light emitting portions and the liquid crystal panel and including a prism portion having a plurality of prisms on a side facing the plurality of light emitting portions and a lens portion having a plurality of lenticular lenses arranged in the first direction on a side facing the liquid crystal panel. The plurality of light emitting portions are configured to emit illumination light from the light emitting surface. The prism portion is configured to split the illumination light into transmitted light and refracted light. The lens portion is configured to diffuse the transmitted light and the refracted light. The liquid crystal panel is configured to be illuminated by the transmitted light and the refracted light and display a first image based on the transmitted light and a second image based on the refracted light.

This configuration enables a display device capable of improving display qualities.

Embodiments will be described with reference to the accompanying drawings.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective parts are illustrated schematically in the drawings, rather than as an accurate representation of what is implemented. However, such schematic illustration is merely exemplary, and in no way restricts the interpretation of the invention. In addition, in the specification and drawings, structural elements which function in the same or a similar manner to those described in connection with preceding drawings are denoted by like reference numbers, detailed description thereof being omitted unless necessary.

In the figures, an X-axis, a Y-axis orthogonal to the X-axis, and a Z-axis orthogonal to the X-axis are described to facilitate understanding as needed. A direction parallel to the X-axis is referred to as a first direction X. A direction parallel to the Y-axis is referred to as a second direction Y. A direction parallel to the Z-axis is referred to as a third direction Z. A plan view is defined as appearance when various types of elements are viewed parallel to the third direction Z. When terms indicating the positional relationships of two or more structural elements, such as “on”, “above” “between” and “face”, are used, the target structural elements may be directly in contact with each other or may be spaced apart from each other as a gap or another structural element is interposed between them. The positive direction of the Z-axis is referred to as an upward direction or a direction to an upper side.

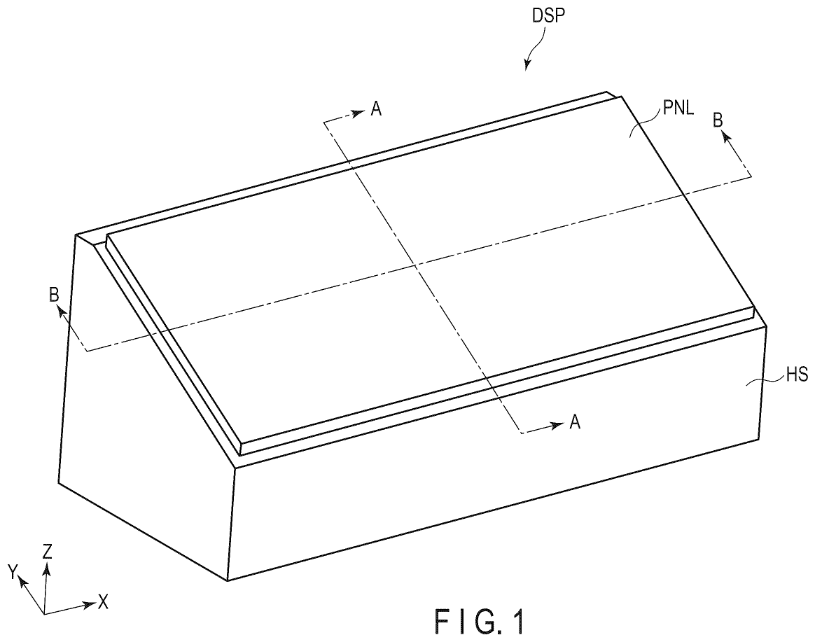

FIG. 1 is a schematic view showing an exterior appearance of a display device DSP.

The display device DSP comprises a liquid crystal panel PNL and a housing HS. The display device DSP of the present embodiment includes an illumination device for illuminating the liquid crystal panel PNL and is applicable, for example, to a vehicle-mounted display device.

The liquid crystal panel PNL is provided parallel to the X-Y plane defined by the first direction X and the second direction Y and is inclined relative to the third direction Z. In the illustrated example, the liquid crystal panel PNL has a flat plate shape extending in the first direction X. The long sides of the liquid crystal panel PNL are parallel to the first direction X. The short sides of the liquid crystal panel PNL are parallel to the second direction Y. The planar shape of the liquid crystal panel PNL is not limited to a rectangular shape shown in FIG. 1 and may be another shape such as a circular shape, an elliptical shape, or a polygonal shape other than a square.

The display panel PNL is configured to display an image by selectively transmitting illumination light. Here, the liquid crystal panel PNL can display two types of images. For example, the liquid crystal panel PNL is configured to display two types of images facing different directions using a parallax barrier method.

The housing HS is formed in a box-like shape to hold the liquid crystal panel PNL and to accommodate elements constituting the display device DSP including elements for generating illumination light. The shape of the housing HS is not limited to this example and may be any desired shape.

### First Embodiment

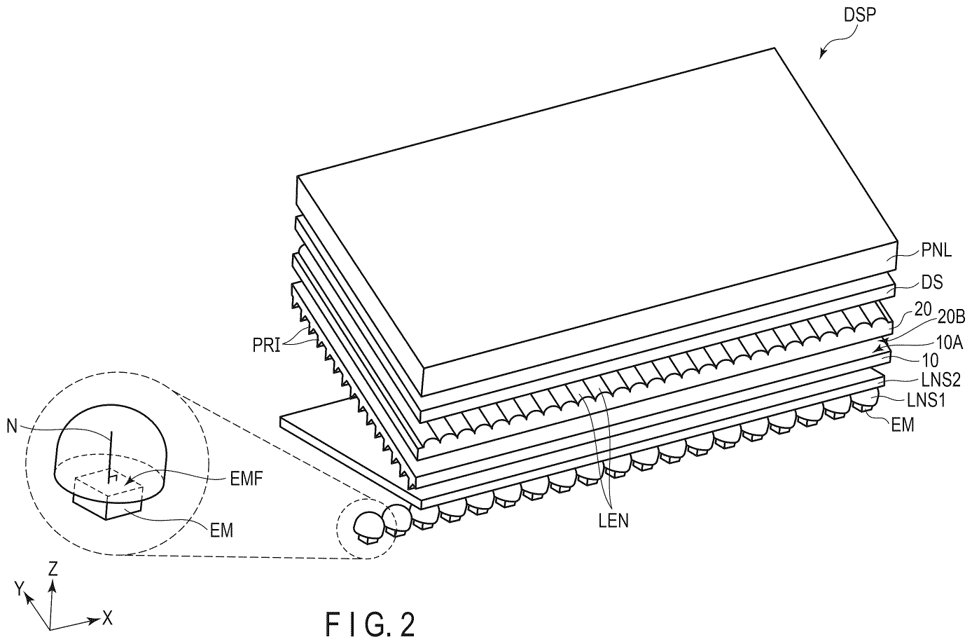

FIG. 2 is a schematic view showing a configuration of the display device DSP in the first embodiment.

In addition to the liquid crystal panel PNL, the display device DSP according to the first embodiment comprises a plurality of light emitting portions EM, a plurality of first lenses LNS1, a second lens LNS2, a prism sheet 10, a lens element 20, and an isotropic diffusion sheet DS as elements for generating illumination light.

The plurality of light emitting portions EM are arranged at intervals in the first direction X. In the illustrated example, the light emitting elements EM are arranged in a line. Each of the plurality of light emitting portions EM has a light emitting surface EMF as shown in an enlarged manner. In one example, each of the plurality of light emitting portions EM is provided such that a normal N of its emitting surface EMF is parallel to the third direction Z. For example, the plurality of light emitting portions EM are light emitting diodes.

The plurality of first lenses LNS1 are provided to respectively face the plurality of light emitting portions EM in the third direction Z. That is, the plurality of first lenses LNS1 are arranged at intervals in the first direction X. In the example of FIG. 2, each of the plurality of first lenses LNS1 has a circular bottom surface facing the light emitting surface EMF and a curved surface (a convex surface) facing the prism sheet 10. In one example, the bottom surface of the first lenses LNS1 is parallel to the light emitting surface EMF facing the bottom surface.

The second lens LNS2 is located between the first lenses LNS1 and the prism sheet 10 in the third direction Z. In the illustrated example, the second lens LNS2 is formed in a flat plate shape extending in the first direction X and has a lens portion such as a fresnel lens on at least one of the side facing the first lenses LNS1 and the side facing the prism sheet 10. The second lens LNS2 is provided such that the optical axis of the lens portion is parallel to the third direction Z. That is, the second lens LNS2 is orthogonal to the normal N of the light emitting surface EMF which each of the plurality of light emitting portions EM has.

The prism sheet 10 is located between the plurality of light emitting portions EM and the liquid crystal panel PNL in the third direction Z. In the illustrated example, the prism sheet 10 is located between the second lens LNS2 and the lens element 20. The prism sheet 10 has a plurality of prisms PRI on the side facing the plurality of light emitting portions EM and has a first flat surface 10A on the opposite side. For example, the prism sheet 10 is provided such that the first flat surface 10A is inclined relative to the normal N of the light emitting surface EMF which each of the plurality of light emitting portions EM has.

The lens element 20 is located between the prism sheet 10 and the liquid crystal panel PNL in the third direction Z. In the illustrated example, the lens element 20 is located between the prism sheet 10 and the isotropic diffusion sheet DS. The lens element 20 has a plurality of lenticular lenses LEN on the side facing the liquid crystal panel PNL and has a second flat surface 20B on the opposite side. The second flat surface 20B faces the first flat surface 10A. For example, the lens element 20 is provided such that the second flat surface 20B is inclined relative to the normal N of the light emitting surface EMF which each of the plurality of light emitting portions EM has. Further, the second flat surface 20B is parallel to the first flat surface 10A.

The isotropic diffusion sheet DS is located between the lens element 20 and the liquid crystal panel PNL in the third direction Z. In the example of FIG. 2, the isotropic diffusion sheet DS is a flat plate shape extending in the first direction X and is provided to be inclined relative to the normal N of the light emitting surface EMF which each of the plurality of light emitting portions EM has.

The liquid crystal panel PNL is provided to face the lens element 20 in the third direction Z. In the illustrated example, the liquid crystal panel PNL faces the isotropic diffusion sheet DS. The liquid crystal panel PNL is inclined relative to the normal N of the light emitting surface EMF which each of the plurality of light emitting portions EM has. In one example, the prism sheet 10 is provided such that the first flat surface 10A is parallel to the liquid crystal panel PNL, and the lens element 20 is provided such that the second flat surface 20B is parallel to the liquid crystal panel PNL. In one example, air layers are interposed between the prism sheet 10 and the lens element 20, between the lens element 20 and the isotropic diffusion sheet DS, and between the isotropic diffusion sheet DS and the liquid crystal panel PNL.

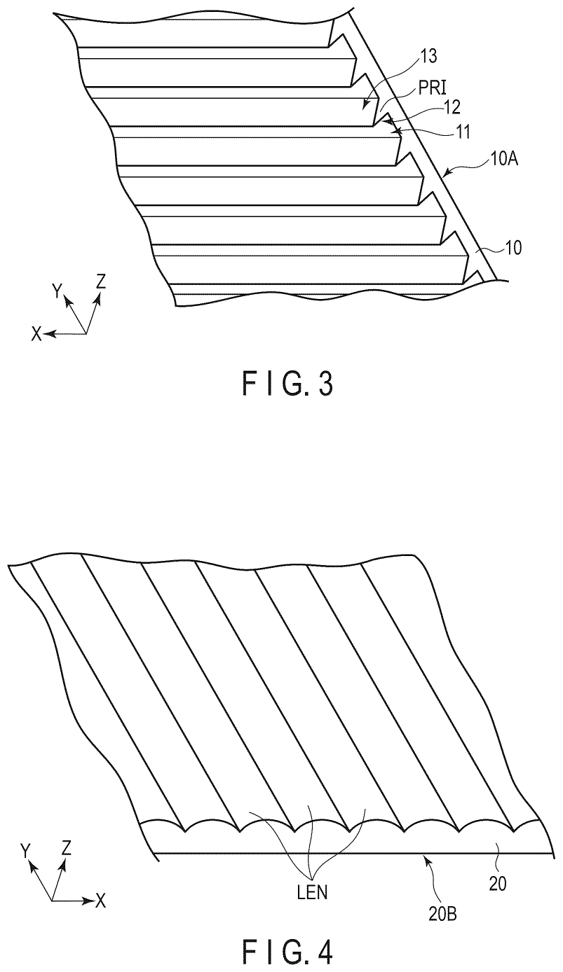

FIG. 3 is a view showing part of the prism sheet 10 in an enlarged manner. FIG. 3 shows part of the prism sheet 10 as viewed from the light emitting portion EM side.

The prism sheet 10 has the plurality of prisms PRI on one side and has the first flat surface 10A on the opposite side. In the present embodiment, the plurality of prisms PRI are arranged in the second direction Y. Further, in plan view, the direction in which the plurality of prisms PRI are arranged is orthogonal to the direction in which the plurality of light emitting portions EM shown in FIG. 2 are arranged.

A first incident surface 11 is provided between adjacent prisms PRI. In one example, the first incident surface 11 is parallel to the first flat surface 10A. That is, the first incident surface 11 is parallel to the liquid crystal panel PNL.

Each of the plurality of prisms PRI is formed in a triangular prism shape. In the Y-Z plane defined by the second direction Y and the third direction Z, the cross section of the prism PRI is triangular. Each of the plurality of prisms PRI has two faces intersecting the first incident surface 11 at an angle greater than 90°. One of the two faces functions as a second incident surface 12. The other face functions as a first reflective surface 13. The second incident surface 12 and the first reflective surface 13 face each other in the second direction Y. That is, each of the plurality of prisms PRI extends in the first direction X. That is, each of the first incident surface 11, the second incident surface 12, and the first reflective surface 13 extends in the first direction X.

FIG. 4 is a view showing part of the lens element 20 in an enlarged manner. FIG. 4 shows part of the lens element 20 as viewed from the liquid crystal panel side.

The lens element 20 includes the plurality of lenticular lenses LEN on one side and has the second flat surface 20B on the opposite side. In the present embodiment, the plurality of lenticular lens LEN are arranged in the first direction X. That is, the plurality of lenticular lens LEN and plurality of light emitting portions EM shown in FIG. 2 are arranged in the same direction. Further, each of the plurality of lenticular lenses LEN extends in the second direction Y.

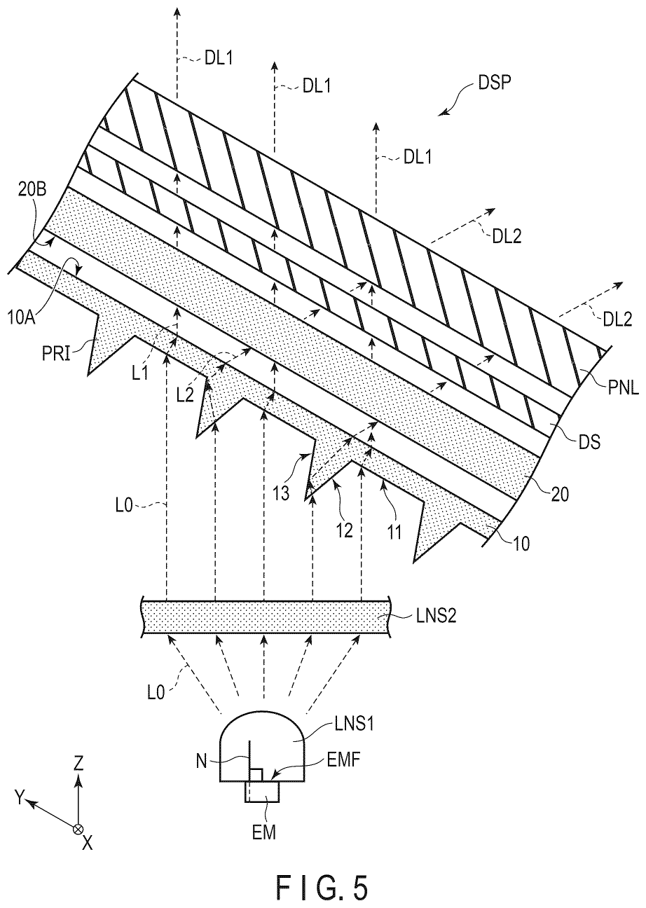

FIG. 5 is a schematic A-A cross-sectional view of the display device DSP shown in FIG. 1 according to the first embodiment. FIG. 5 shows the traveling direction of light by dashed arrows.

The light emitting element EM is configured to emit an illumination light L0 from the light emitting surface EMF toward the liquid crystal panel PNL. The illumination light L0 travels along the third direction Z but is divergent light.

The first lens LNS1 is configured to concentrate the illumination light L0 emitted from the light emitting element EM.

The second lens LNS2 is configured to collimate the illumination light L0 concentrated by the first lenses LNS1. The illumination light L0 having passed through the second lens LNS2 is collimated light traveling along the third direction Z.

The prism sheet 10 is configured to split the illumination light L0 having passed through the second lens LNS2 into a transmitted light L1 and a refracted light L2. Specifically, the illumination light L0 entering from the first incident surface 11 is emitted from the first flat surface 10A as the transmitted light L1, hardly affected by the prism sheet 10. Thus, the transmitted light L1 travels along the third direction Z.

In contrast, the illumination light L0 entering each of the prisms PRI is refracted in a direction different from the third direction Z. More specifically, part of the illumination light L0 entering from the second incident surface 12 of the prisms PRI and then refracted is reflected at the first reflective surface 13 and then emitted from the first flat surface 10A as the refracted light L2. In this case, the refracted light L2 travels in a direction different from that of the transmitted light L1.

The prism sheet 10 can adjust the light intensity of the transmitted light L1 and the light intensity of the refracted light L2 by changing the intervals between the adjacent prisms PRI.

The lens element 20 is configured to diffuse the transmitted light L1 and the refracted light L2 emitted from the prism sheet 10. The isotropic diffusion sheet DS is configured to further diffuse the transmitted light L1 and the refracted light L2 diffused by the lens element 20.

The liquid crystal panel PNL is configured to be illuminated by the transmitted light L1 and the refracted light L2 and display the first image based on the transmitted light L1 and the second image based on the refracted light L2. The first image and the second image differ from each other. For example, in the liquid crystal panel PNL, pixels in the area illuminated by the transmitted light L1 are driven by a video signal corresponding to the first image, and pixels in the area illuminated by the refracted light L2 are driven by a video signal corresponding to the second image.

A first display light DL1 forming the first image is projected, for example, onto a vehicle's front shield, a combiner, and the like to be visually recognizable by a user. Further, a second display light DL2 forming the second image is directly visually recognizable by a user.

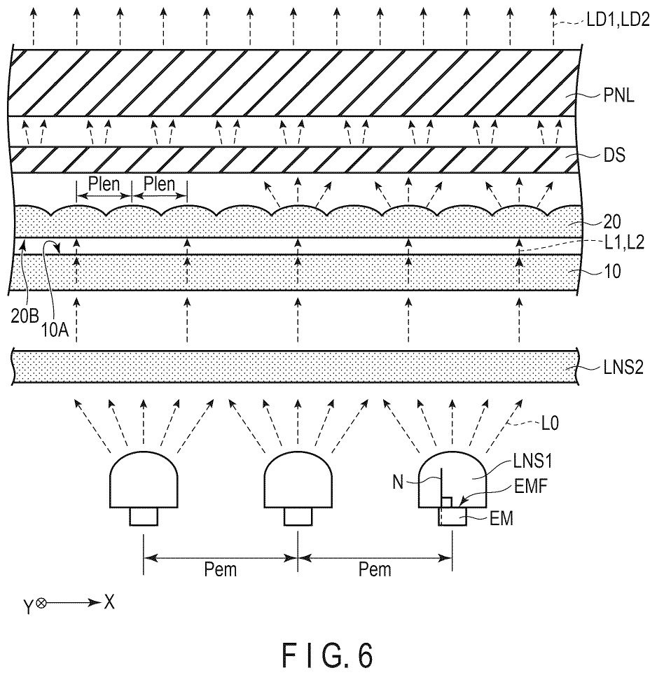

FIG. 6 is a schematic B-B cross-sectional view of the display device DSP according to the first embodiment shown in FIG. 1. In the same manner as FIG. 5, FIG. 6 shows the traveling direction of light by dashed arrows.

The plurality of light emitting portions EM are arranged at a uniform pitch Pem in the first direction X. The prism sheet 10 splits the illumination light L0 emitted from the light emitting surfaces EMF of the plurality of light emitting portions EM into the transmitted light L1 and the refracted light L2.

The plurality of lenticular lens LEN are arranged at a uniform pitch Plen in the first direction X. As shown in FIG. 6, the pitch Plen of the plurality of lenticular lenses LEN is smaller than the pitch Pem of the plurality of light emitting portions EM.

The transmitted light L1 and the refracted light L2 are diffused by each of the lenticular lenses LEN. At this time, each of the plurality of lenticular lenses LEN diffuses the transmitted light L1 and refracted light L2 more strongly in the first direction X than in the second direction Y.

The isotropic diffusion sheet DS further diffuses the transmitted light L1 and the refracted light L2 diffused by the lens elements 20. Unlike each of the plurality of lenticular lenses LEN, the isotropic diffusion sheet DS diffuses the incident transmitted light L1 and refracted light L2 almost equally in all directions of the X-Y plane.

The transmitted light L1 and refracted light L2 diffused by the isotropic diffusion sheet DS are emitted by the liquid crystal panel PNL as the first display light DL1 forming the first image and the second display light DL2 forming the second image.

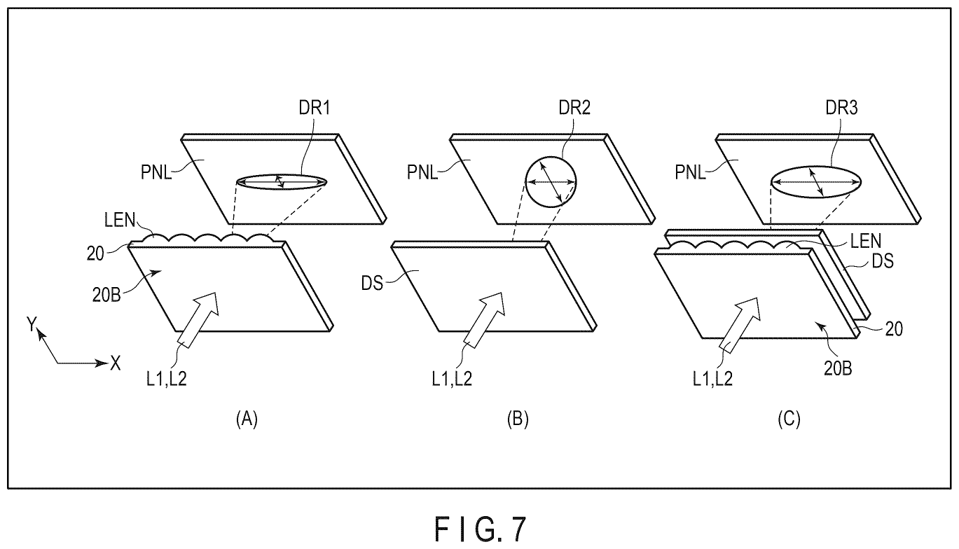

FIG. 7 is a view describing effects of the lenticular lens LEN and the isotropic diffusion sheet DS. FIG. 7 omits the illustration of the elements other than the lens element 20, the isotropic diffusion sheet DS, and the liquid crystal panel PNL.

The liquid crystal panel PNL shown in FIG. 7 is provided parallel to the X-Y plane. Further, the lens element 20 is provided such that the second flat surface 20B is parallel to the liquid crystal panel PNL. The isotropic diffusion sheet DS is provided parallel to the liquid crystal panel PNL.

The plurality of lenticular lenses LEN included in the lens element 20 are arranged in the first direction X. Each of the plurality of lenticular Lenses LEN extends in the second direction Y. The following will conceptually describe the diffusion ranges of the transmitted light L1 and the refracted light L2 for each of the cases: (A) the lens element 20 alone; (B) the isotropic diffusion sheet DS alone; and (C) the combination of the lens element 20 and the isotropic diffusion sheet DS.

As shown on the left side of the figure, in the case of “(A) the lens element 20 alone”, the transmitted light L1 and refracted light L2 emitted from the prism sheet 10 are diffused into a first diffusion range DR1 indicated by an ellipse extending in the first direction X. That is, in cases where the plurality of lenticular lenses LEN are arranged in the first direction X, the lens element 20 has a function to diffuse the transmitted light L1 and the refracted light L2 more strongly in the first direction X than in the second direction Y.

As shown in the center of the figure, in the case of “(B) the isotropic diffusion sheet DS alone”, the transmitted light L1 and the refracted light L2 both emitted from the prism sheet 10 are diffused into a second diffusion range DR2 indicated by a circle. That is, the isotropic diffusion sheet DS diffuses the transmitted light L1 and the refracted light L2 with substantially the same diffusion strength in the first direction X and in the second direction Y.

As shown in the right side of the figure, in the case of “(C) the combination of the lens element 20 and the isotropic diffusion sheet DS”, the transmitted light L1 and the refracted light L2 both emitted from the prism sheet 10 are diffused into a third diffusion range DR3 indicated by an ellipse extending in the first direction X. At this time, the length of the short axis of the third diffusion range DR3 along the second direction Y is longer than the length of the short axis of the first diffusion range DR1. That is, combining the lens element 20 with the isotropic diffusion sheet DS results in stronger diffusion in the second direction Y than using the lens element 20 alone.

Here, in cases where the plurality of light emitting portions EM are arranged along the first direction X, high-brightness areas and low-brightness areas alternate along the first direction X. This configuration tends to form stripe-like brightness irregularities parallel to the second direction Y in the transmitted light L1 and refracted light L2 illuminating the liquid crystal panel PNL. To suppress these brightness irregularities, the transmitted light L1 and the refracted light L2 have to be diffused along the first direction X.

In this regard, as shown in FIG. 7, the lens element 20 has the function of strongly diffusing incident light in the direction along which the plurality of lenticular lenses LEN are arranged. Thus, the display device DSP comprising the lens element 20 suppresses the stripe-like brightness irregularities.

Furthermore, comprising the isotropic diffusion sheet DS in addition to the lens element 20 makes the light diffusion range broader and suppresses the stripe-like brightness irregularities more than comprising the lens element 20 alone. Thus, the display quality of images displayed in the liquid crystal panel PNL can be increased.

If a desired diffusion performance can be achieved by the lens element 20 alone, the isotropic diffusion sheet DS may be omitted.

Here, comprising an anisotropic diffusion sheet may be another means to reduce the stripe-like brightness irregularities. However, anisotropic diffusion sheets involve greater luminance loss at the time of extracting light than the lens element 20.

Furthermore, anisotropic diffusion sheets generally have limited applications. Thus, anisotropic diffusion sheets are more expensive than the combination of the isotropic diffusion sheet DS and the lens element 20 comprising the plurality of lenticular lenses LEN. Thus, the display device DSP according to the present embodiment can reduce manufacturing costs more than display devices comprising anisotropic diffusion sheets.

### Second Embodiment

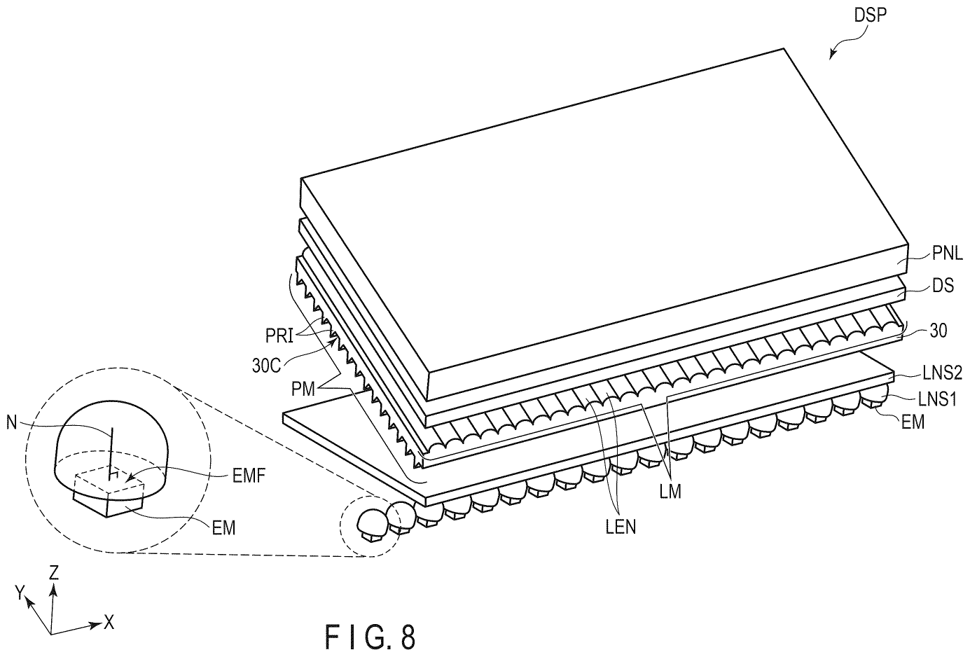

FIG. 8 is a schematic view showing a configuration example of a display device DSP according to the second embodiment.

The configuration example shown in FIG. 8 differs from the configuration example shown in FIG. 2 in comprising an optical element 30 instead of the prism sheet 10 and the lens element 20. The optical element 30 is located between the plurality of light emitting portions EM and the liquid crystal panel PNL in the third direction Z. In the illustrated example, the optical element 30 is located between the second lens LNS2 and the isotropic diffusion sheet DS. The optical element 30 has a prism portion PM on the side facing the plurality of light emitting portions EM and has a lens portion LM on the side facing the liquid crystal panel PNL.

The prism portion PM has the plurality of prisms PRI arranged at intervals in the second direction Y. A third flat surface 30C is provided between adjacent prisms PRI. In one example, the optical element 30 is provided such that the third flat surface 30C is parallel to the liquid crystal panel PNL.

The lens portion LM has the plurality of lenticular lenses LEN. The plurality of lenticular lenses LEN are arranged in the first direction X.

In one example, air layers are interposed between the optical element 30 and the isotropic diffusion sheet DS and between the isotropic diffusion sheet DS and the liquid crystal panel PNL.

The same structural elements as those of the first embodiment shown in FIG. 2 to FIG. 6 are denoted by the same reference numbers, and their overlapping descriptions are omitted.

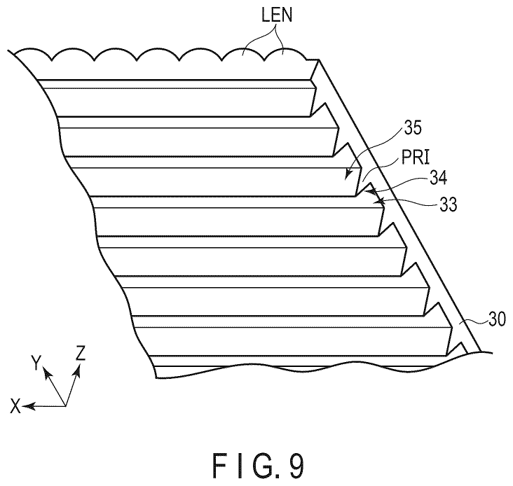

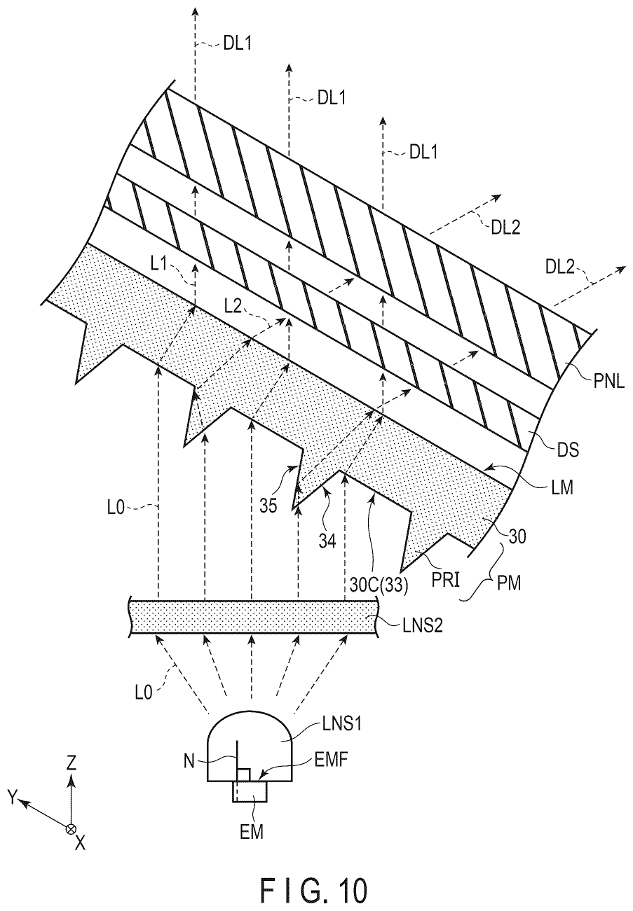

FIG. 9 is a view showing part of the optical element 30 in an enlarged manner. FIG. 9 shows part of the optical element 30 as viewed from the light emitting portion EM side.

The third flat surface 30C is provided between adjacent prisms PRI. Hereinafter, the third flat surface 30C is also referred to as a third incident surface 33. In one example, the third flat surface 30C is parallel to the liquid crystal panel PNL.

Each of the plurality of prisms PRI is formed in a triangular prism shape. In the Y-Z plane defined by the second direction Y and the third direction Z, the cross section of the prism PRI is triangular. Each of the plurality of prisms PRI has two faces intersecting the third incident surface 33 at an angle greater than 90°. One of the two faces functions as a fourth incident surface 34. The other face functions as a second reflective surface 35. The fourth incident surface 34 and the second reflective surface 35 face each other in the second direction Y. That is, each of the plurality of prisms PRI extends in the first direction X. That is, each of the third incident surface 33, the fourth incident surface 34, and the second reflective surface 35 extends in the first direction X.

FIG. 10 is a schematic A-A cross-sectional view of the display device DSP shown in FIG. 1 according to the second embodiment.

The optical element 30 is configured to split the illumination light L0 having passed through the second lens LNS2 into the transmitted light L1 and the refracted light L2 using the prism portion PM and diffuses the split light using the lens portion LM. Specifically, the illumination light L0 entering from the third incident surface 33 travels toward the lens portion LM, hardly affected by the prism portion PM. This illumination light L0 is diffused by the plurality of lenticular lenses LEN in the lens portion LM and emitted as the transmitted light L1. Thus, the transmitted light L1 travels along the third direction Z.

In contrast, the illumination light L0 entering from the fourth incident surface 34 of the prism PRI is refracted by each of the plurality of prisms PRI. Part of the illumination light L0 that has entered from the fourth incident surface 34 and been refracted is reflected by the second reflective surface 35 and travels toward the lens portion LM. This illumination light L0 is diffused by the plurality of lenticular lenses LEN in the lens portion LM and emitted as the refracted light L2. In this case, the refracted light L2 travels in a direction different from the third direction Z.

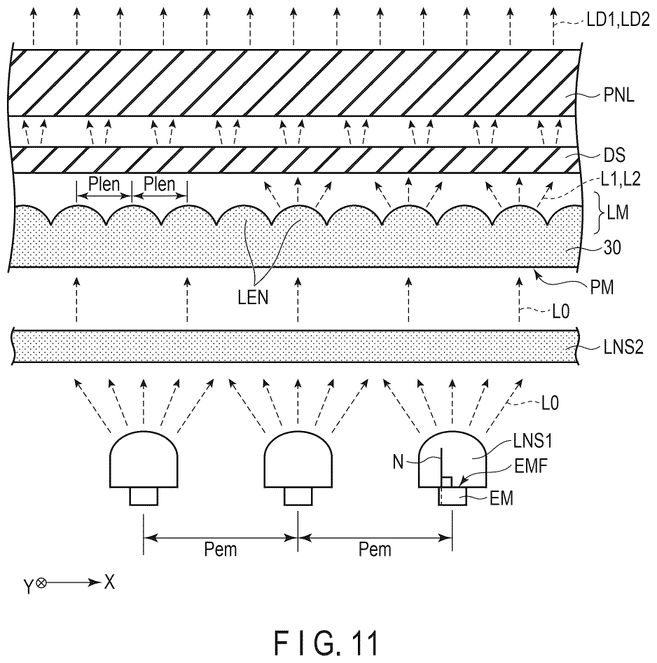

FIG. 11 is a schematic B-B cross-sectional view of the display device DSP shown in FIG. 1 according to the second embodiment.

The prism PM splits the illumination light L0 emitted from the light emitting surfaces EMF of the plurality of light emitting portions EM arranged in the first direction X into two types of light traveling in respective different directions in the optical element 30. The two types of split light are diffused by each of the lenticular lenses LEN arranged in the first direction X and then emitted as the transmitted light L1 and the refracted light L2.

This display device can integrate the prism sheet 10 and the lens element 20 which the display device DSP according to the first embodiment comprises, thereby further reducing the manufacturing cost of the display device DSP.

Furthermore, this display device suppresses undesirable light reflections that may occur between the prism sheet 10 and the lens element 20 which the display device DSP according to the first embodiment comprises, thereby further improving the display quality.

The embodiments described above can provide a display device capable of improving the display quality.

All of the display devices that can be implemented by a person of ordinary skill in the art through arbitrary design changes to the display device described above as the embodiment of the present invention come within the scope of the present invention as long as they are in keeping with the spirit of the present invention.

Various modification examples which may be conceived by a person of ordinary skill in the art in the scope of the idea of the present invention will also fall within the scope of the invention. For example, even if a person of ordinary skill in the art arbitrarily modifies the above embodiments by adding or deleting a structural element or changing the design of a structural element, or adding or omitting a step or changing the condition of a step, all of the modifications fall within the scope of the present invention as long as they are in keeping with the spirit of the invention.

Further, other effects which may be obtained from each embodiment and are self-explanatory from the descriptions of the specification or can be arbitrarily conceived by a person of ordinary skill in the art are considered as the effects of the present invention as a matter of course.

What is claimed is

1. A display device, comprising:
a plurality of light emitting portions arranged in a first direction;
a liquid crystal panel inclined relative to a normal to a light emitting surface which each of the plurality of light emitting portions has;
a prism sheet located between the plurality of light emitting portions and the liquid crystal panel and having a plurality of prisms on a side facing the plurality of light emitting portions; and
a lens element located between the prism sheet and the liquid crystal panel and including a plurality of lenticular lenses arranged in the first direction on a side facing the liquid crystal panel, wherein
the plurality of light emitting portions are configured to emit illumination light from the light emitting surface,
the prism sheet is configured to split the illumination light into transmitted light and refracted light,
the lens element is configured to diffuse the transmitted light and the refracted light, and
the liquid crystal panel is configured to be illuminated by the transmitted light and the refracted light and display a first image based on the transmitted light and a second image based on the refracted light.

2. The display device of claim 1, wherein
the prism sheet has a first flat surface on a side opposite to the plurality of prisms,
the lens element has a second flat surface on a side opposite to the plurality of lenticular lenses, and
the first flat surface faces the second flat surface.

3. The display device of claim 2, wherein
the prism sheet is provided for the first flat surface to be parallel to the liquid crystal panel, and
the lens element is provided for the second flat surface to be parallel to the liquid crystal panel.

4. The display device of claim 1, further comprising:
an isotropic diffusion sheet located between the lens element and the liquid crystal panel.

5. The display device of claim 4, wherein
air layers are interposed between the prism sheet and the lens element, between the lens element and the isotropic diffusion sheet, and between the isotropic diffusion sheet and the liquid crystal panel.

6. The display device of claim 1, further comprising:
a plurality of first lenses facing the light emitting surface of the plurality of light emitting portions respectively and configured to concentrate the illumination light; and
a second lens facing the plurality of first lenses and configured to collimate the illumination light having passed through the first lens.

7. The display device of claim 1, wherein
each of the plurality of prisms extends in the first direction,
the plurality of prisms are arranged in a second direction orthogonal to the first direction, and
each of the plurality of lenticular lenses extends in the second direction.

8. The display device of claim 1, wherein
a pitch of the plurality of lenticular lenses in the first direction is smaller than a pitch of the plurality of light emitting portions in the first direction.

9. A display device, comprising:
a plurality of light emitting portions arranged in a first direction;
a liquid crystal panel inclined relative to a normal to a light emitting surface which each of the plurality of light emitting portions has; and
an optical element located between the plurality of light emitting portions and the liquid crystal panel and including a prism portion having a plurality of prisms on a side facing the plurality of light emitting portions and a lens portion having a plurality of lenticular lenses arranged in the first direction on a side facing the liquid crystal panel, wherein
the plurality of light emitting portions are configured to emit illumination light from the light emitting surface,
the prism portion is configured to split the illumination light into transmitted light and refracted light,
the lens portion is configured to diffuse the transmitted light and the refracted light, and
the liquid crystal panel is configured to be illuminated by the transmitted light and the refracted light and display a first image based on the transmitted light and a second image based on the refracted light.

10. The display device of claim 9, wherein
the prism portion has a third flat surface between the prisms that are adjacent to each other, and
the optical element is provided for the third flat surface to be parallel to the liquid crystal panel.

11. The display device of claim 9, further comprising:
an isotropic diffusion sheet located between the optical element and the liquid crystal panel.

12. The display device of claim 11, wherein
air layers are interposed between the optical element and the isotropic diffusion sheet and between the diffusion sheet and the liquid crystal panel.

13. The display device of claim 9, further comprising:
a plurality of first lenses facing the light emitting surface of the plurality of light emitting portions respectively and configured to concentrate the illumination light; and
a second lens facing the plurality of first lenses and configured to collimate the illumination light having passed through the first lens.

14. The display device of claim 9, wherein
each of the plurality of prisms extends in the first direction,
the plurality of prisms are arranged in a second direction orthogonal to the first direction, and
each of the plurality of lenticular lenses extends in the second direction.

15. The display device of claim 9, wherein
a pitch of the plurality of lenticular lenses in the first direction is smaller than a pitch of the plurality of light emitting portions in the first direction.
